(19) United States
(12) Patent Application Publication
(10) Pub. No.: US 2019/0301794 A1
(43) Pub. Date: Oct. 3, 2019

(54) TRANSPORT METHOD FOR TEMPERATURE-CONTROLLED PRODUCTS, TRANSPORT CONTAINER, CONDITIONING DEVICE AND CONTROL SOFTWARE

(71) Applicant: CELSIUS ENTWICKLUNG GMBH, Radebeul (DE)

(72) Inventor: Hans Peter ESSER, Dresden (DE)

(73) Assignee: Celsius Entwicklung GmbH, Radebeul (DE)

(21) Appl. No.: 16/304,527

(22) PCT Filed: Mar. 24, 2017
(86) PCT No.: PCT/EP2017/057135

§ 371 Date: Nov. 26, 2018

(30) Foreign Application Priority Data
Mar. 24, 2016 (DE) 10 2016 105 621.9
Dec. 2, 2016 (DE) 10 2016 1233 78.1
Feb. 7, 2017 (DE) 10 2017 102 328.3

(51) Int. Cl. F25D 29/00; G06Q 10/08; F25D 3/06; B65D 81/38; B65D 55/02; B65D 79/02; B65D 21/02

(52) U.S. Cl. CPC F25D 29/003; G06Q 10/0832; F25D 3/06; B65D 21/0233; B65D 55/02; B65D 79/02; B65D 81/3823

(57) ABSTRACT

A transport method for temperature-controlled products, a transport container, a conditioning device or filling device, and a control software are proposed. In a method for transporting temperature-controlled products, a transport container containing a product having a product weight is supplied with a preconditioned thermal mass before the start of transport, the quantity of the thermal mass supplied being computationally calculated in advance on the basis of thermodynamically and/or logistically relevant data such as product weight and/or the starting location and destination and/or the estimated transport time and/or weather data at the starting location and/or at the destination and/or between the starting location and destination and/or a temperature range to be maintained.

The invention relates to a transport method for temperature-controlled products, a transport container, a conditioning device or filling device to carry out the method as well as software to monitor and control the method.

Temperature-controlled transport is becoming more and more important. Among the best known product groups, for example, are foodstuffs (especially fresh and highly perishable food), medicines and cosmetics, etc.

The prior art here knows two basic types of transport methods, namely active and passive. The person skilled in the art understands “active” as methods and systems that keep the product at a certain temperature during transport, for example through cooling and/or warming. The best known here are so-called active vehicles, also commonly known as temperature-controlled or refrigerated vehicles. The person skilled in the art understands “passive” as products being packed in such a manner that they transport the product safely from point A to point B while maintaining a certain temperature range based on type of packaging and condition, and partially with the use of assistive equipment.

The assistive equipment accompanying the packaging varies. The best known are solid and liquid insulating materials such as vacuum panels, dry ice, water-based energy storage or so-called latent storage, etc.

The advantages of the temperature-controlled active transport method are easy handling and the temperature control underlying the active transport. Products intended for temperature-controlled transport must not be equipped with insulated packaging. The current temperatures in the active vehicle can be recorded and monitored at all times for control purposes.

The disadvantages of the temperature-controlled active transport method are acquisition costs and ongoing operating costs. Apart from the investment, the driver must have special qualification. “Stop density” likewise has an adverse effect on operating costs. The vehicle is economically profitable when working with a high stop density (e.g. within a city). The vehicle is rather inefficient in rural areas where there is a low stop density. The inability of the active vehicle to handle mixed traffic is also a disadvantage.

The advantages of the temperature-controlled passive transport method mainly involve the fact that logistics providers can transport and handle products as part of their routine business. It is, however, required that product packaging be designed in such a manner that it can also maintain the required temperature range when considering the outside temperatures at the starting location, en route and at the destination, as well as the transit time (transport time) of the product.

A disadvantage of the temperature-controlled passive transport method according to the state of the art is that the necessary assistive equipment for maintaining the required temperature have a so-called static nature. This means that based on the type and condition of all insulated packagings it must be supplied with a so-called thermal mass prior to transport, regardless of the outside temperature, transport route and product weight, in order to maintain the required transport temperature. The necessary thermal mass is added to the product shipment depending on the required transport temperature (for example: 2° C. to 8° C. for cold or 15° C. to 25° C. for ambient).

The addition of thermal mass in the known method is a static process that is not need-based in passive transport according to the prior art but is rather to be regarded as a basic transport requirement.

Another disadvantage is that no shipment monitoring can be carried out (to prove maintenance of the required delivery temperature). It is also disadvantageous that a shipment's packaging weight is very poorly related to product weight (higher weight=higher handling expenditure=higher costs).

An object of the invention is to develop a passive transport method which ensures that every product shipment is delivered within the selected period and temperature range and the proper receipt of the shipment is confirmed by the recipient just like with parcels, based on the thermodynamic requirements and needs of every product shipment and regardless of its size, weight and the desired transport period.

In addition, the transport period using the method should be selected so that products may also be returned to the sender if necessary (such as in case of non-delivery) under temperature-controlled conditions (for example, when taking account of weekend delivery).

The inventive concept can be implemented as described below for example:

Proposed are a transport method for temperature-controlled products, a transport container, a conditioning device or filling device and a control software, which can be used advantageously in the implementation of the method. The transport container, the conditioning device or filling device, the method and the control software are described below and are shown as an example and schematically in the attached drawings.

Proposed is a method for implementing transports of temperature-controlled products, whereby a transport container containing a product having a product weight is supplied with a preconditioned thermal mass before the start of transport, the quantity of the thermal mass supplied being computationally calculated in advance on the basis of thermodynamically and/or logistically relevant data such as product weight and/or the starting location and destination and/or the estimated transport time and/or weather data at the starting location and/or at the destination and/or between the starting location and destination and/or a temperature range to be maintained.

An important basic idea with respect to the known method is that it can be established individually for every transport container, based on data that is used for the calculation and that is different for every transport container,
whether transport is at all possible from the starting location to the destination in the desired temperature range under passive temperature control within the transport time needed for the transport route,
if this is possible, whether the given temperature range can be maintained without any additional thermal mass (that is, alone), given the heat insulation of the transport container, and
if this is impossible, which type and quantity of thermal mass is needed for this shipment.

For the first time the proposed method allows the use of only as much thermal mass as is absolutely necessary to maintain the temperature range so that unnecessary transport weight is avoided. The proportion of the thermal mass can be freely adjusted to the individual case based on the prior calculation.

Further advantages of specific embodiments of the method involve the fact that the maintenance of the temperature range and/or a preselectable maximum transport time can be monitored, and that the delivery of shipments can be prevented if the shipment were to take too long en route and/or if their temperature were to depart from the given temperature range and/or if they were opened without authorization before delivery to the legitimate recipient.

The proposed transport method can distinguish itself by specific embodiments, for example, in that three components interact: a transport container for the products to be transported, a conditioning device or filling device and a method whose algorithm can be implemented in a control software, for example, wherein parts of the control software can be distributed in specific embodiments such as on the transport container, the conditioning device or filling device, transport vehicles used for the method, mobile or stationary read-write devices and so on.

The transport container, for example, can have at least one cavity, preferably two, possibly three or more cavities that are separate from each other in an airtight and watertight manner.

The transport container can be designed as a solid body or as a flexible packaging. The product to be transported, for example, can be placed in a first cavity and this first cavity can then be closed, for example. The transport container, for example, can be made of plastic, cardboard, paper or sheet or combinations of these materials.

Furthermore, the transport container can have at least one container wall that is heat-insulating, that is, thermally non-conductive or slightly conductive. This can be realized, for example, through the use of insulating materials such as foam materials and/or through vacuum. The insulation, for example, can be mounted inside the box and enclose the product.

The design can be such, for example, that at least one container wall of the top part and/or bottom part of the transport container has a heat-insulating layer.

The heat-insulating layer, for example, can contain amorphous silicon dioxide such as precipitated (CAS No. 112926-00-8) or pyrogenous (CAS No. 112945-52-5 and 60842-32-2) silicon dioxide as an insulating material. The CAS number (also CAS registry number, CAS=Chemical Abstracts Service) is an international standard naming convention for chemical substances.

Furthermore, the design can be such that the heat-insulating layer has an impermeable shell enveloping the insulating material and is pumped down. One such impermeable shell can, for example, be made of a thermoplastic film such as polypropylene, polyethylene or the like. If, for example, amorphous silicon dioxide is shrink-wrapped and pumped down to an impermeable polymer film, one obtains insulation panels with a high degree of heat insulation.

The heat-insulating layer can, for example, be designed as a one-piece, three-dimensional (for example, bowl-shaped) structure following the contour of the bottom part or the top part, through which thermal bridges can be prevented effectively. Heat-insulating layers as described above can be embedded in a container wall particularly advantageously so that they are protected from damage.

Additional cavities in the transport container can receive media such as liquids or gels or ice particles or mixtures of the above-mentioned media as a thermal mass, or contain air or other gases in order to act as an cushion for sensitive products (dampening media). Slush ice, that is, a mixture of ice particles and water, can be used advantageously as the thermal mass. Slush ice has the advantage of being able to be conducted through pipes like water. The water or/and the ice can contain dissolved salt as needed.

In certain embodiments the additional cavities can be filled with a conditioning device or filling device from the outside, that is, through a container wall and/or through an insulation without having to open the closure or transport container lid. Thus the products to be transported remain protected in a sealed interior space inside the transport container when the cavity or cavities are filled with thermal mass.

The transport container can, for example, have a technical installation (for example, in the form of an electronic mechanism) to record, store and pass on thermodynamically and logistically relevant data such as temperature, humidity or destination of the transport container.

The conditioning device or filling device can, for example, be a technical device that can feed thermal mass and dampening media into the corresponding cavity in the interior of the transport container.

Furthermore, the conditioning device or filling device can, for example, have a media connection and/or a scale to calculate the thermal mass already inside the transport container (that is, the transported goods) and/or an additional thermal mass for the temperature control of the transported goods, as described above. In addition, the conditioning device or filling device can have a communication interface so that thermodynamically and logistically relevant data of the transport container can be read.

Exemplary embodiments of the conditioning device or filling device are hoses with connectors, pouring vessels, semi-automatic or fully automatic systems.

The process can be controlled, for example, using an algorithm which can be implemented through software, for example, which interacts with certain technical equipment such as an electronic circuit of a transport container and/or a conditioning device or filling device and/or a transport vehicle and/or a read-write device and records certain states or reads data and/or makes calculations and/or controls technical equipment as described above and/or transmits data to such technical equipment or writes into them.

The algorithm can, for example, read and process information that is saved or displayed on, to or in the transport container or its components (for example, a label, an electronic circuit, a display or the like). This information can, for example, relate to the mass and/or the temperature of the product, the current location of the transport container, the destination, the current temperature on site and at the destination, etc.

The algorithm can, for example, calculate and evaluate the transit time of the transport container and/or the temperatures on the transport route, whether the thermal energy of the transport container is sufficient or whether and, if necessary, how much additional (negative) thermal energy has to be added to the transport container through media. This algorithm can, for example, be written down in the form of a software, further processed on a PC or server, for example, and further control one or more conditioning devices or filling devices, for example.

To ensure implementation of the inventive concept, a transport container that can have the following features, for example, is proposed:

The transport container can, for example, comprise a bottom part and a lid that is connectable and hermetically sealed with the bottom part. The bottom part and the lid advantageously have interacting closure elements which are preferably designed so that the closure elements can be closed and/or sealed without any possibility of tampering.

The closure elements can, for example, be designed as claws that are either hinged to the bottom part of the transport container and overlap with the lid in the closed position, or are hinged to the transport container lid and overlap with arranged sections on the bottom part in the closed position. The closure elements are advantageously designed so that they press the lid onto the bottom part against the force of an elastic gasket disposed on the lid or on the bottom part.

Furthermore, this type of closure element can comprise a mechanical lock that preferably can be activated electrically, magnetically or electromagnetically. Likewise included are locks that can be activated by shape memory actuators. A striker pin, for example, can be held in a closed position by the force of a spring and be connected to a wire made of a shape memory alloy, which shortens upon application of an electrical voltage and hence moves the striker pin from the closed position to an open position against the force of the spring.

The activation of the lock, that is, the triggering a closing process to open or close the lock, can take place without any contact, for example. The triggering of a closing process here can preferably require entry of a code, enabling only authorized persons to open the lock. The code can be transmitted to the recipient before shipment delivery in the form of a TAN, for example, and additionally via a short message, for example.

The bottom parts and/or the lids are advantageously designed so that several bottom parts or lids can be stacked or nested to save space. Furthermore, lid and floor are designed so that several closed transport containers can be stacked on top of each other without risk of slipping.

The transport container can also have means to identify the size and weight of the transport container and/or of the transported goods. Such means can, for example, comprise optically readable labels, barcodes or the like and/or electronically readable and/or describable labels such as RFID transponders or the like. Such means can also comprise displays (for example, LCD, LED, OLED, eInk displays or the like) which are both optically readable and electronically describable, that is, can be controlled to generate a display. The means to identify the size and weight of the transport container and/or of the transported goods can likewise have combinations of the aforesaid means.

Electronic means such as locks, RFID, displays, speakers, piezoelectric speakers, vibration motors and sensors can preferably be components of an electronic circuit that activates the functions of the individual components and links them to each other.

A component of such an electronic circuit can, for example, be an application-specific integrated circuit (ASIC) or a programmable microcontroller (MCU) acting as a control unit. One or more of the aforesaid functions, for example, no-contact interaction with a user such as the sender, a logistics service provider or the recipient of the transport container, can be directly integrated into a control unit of such type, such interaction taking place through a read-write device, for example, wherein the read-write device can be a smartphone with an installed application-specific software (app), for example. The no-contact interaction can, for example, take place through infrared, Bluetooth or NFC signals (which can be sent and received by RFID transponders, for example) or the like.

Furthermore, such a control unit can be installed to carry out an authorization check and initiate or reject a switching operation of a lock depending on the result of this check. Such a control unit can also control a display, for example, to generate a barcode or a QR code that contains, for example, a unique ID number of the transport container and/or data about the transported goods in plain text or in encrypted form (for example, the mass), and/or the sender and/or the recipient and/or a temperature range to be maintained for the transported goods and/or temperature data of the transported goods (for example, exceeding or falling short of a temperature threshold), and/or an authorization code or data needed to generate an authorization code or the like.

Furthermore, a second control unit can, for example, be disposed on or in the transport container, which has, for example, at least one sensor to measure the temperature and/or humidity, one data logger, one computing unit, one temporary power source and one power transmission interface. This second control unit can be connected to and exchange information with the first control unit. A first sensor can, for example, from the perspective of the insulation, be located inside the transport container and generate data there. A second sensor can, from the perspective of the insulation, be located opposite the first sensor on the exterior of the transport container. This layout allows measurement of insulation capacity through the measurement of the temperature profile.

The electronic components can, for example, be integrated in the transport container in such a manner that they are not visible to the user (with the exception of the display and the keyboard, if available). The energy storage system can, for example, be charged by means of a contactless process through induction or the storage of vibration energy. The start and the end of temperature measurement can be coupled to the current status of the electronic lock (open or closed). Alternatively or additionally, the measured values can be continuously recorded and saved, and it can be further provided, for example, that they are overwritten after a preselectable period or a specified quantity of measured values starting with the oldest measured values, wherein it can also be provided, for example, that the frequency of measured value recording depends on the current status of the electronic lock (open or closed). The measuring interval can, for example, be shorter with a closed lock (corresponding to a higher frequency of measured value recording) than with an open lock.

Based on its type and condition, the transport container should have an insulating effect whose performance is largely constant.

Therefore the transport container advantageously has a heat insulation layer. This can, for example, have an insulating material such as mineral wool, polystyrene, glass fibers, silicon dioxide (also commonly known as silicic acid) or the like. However, the heat insulation layer is advantageously designed as an evacuated cavity, for example, between two walls of a multi-wall tank. Supporting elements can be disposed in the evacuated cavity to increase stability, and these elements themselves are made of heat-insulating material to prevent thermal bridges. The supporting elements can also be integrated into the walls of the transport container. Alternatively or additionally, the insulating material can also be introduced into an impermeable shell and pumped down into this shell. In this case, supporting elements are not required because the negative pressure of the vacuum exerts no force on the walls of the transport container.

The container wall advantageously can have one or more impermeable barrier layers which prevent penetration of gas particles such as oxygen or water vapor, for example. The barrier layers can, for example, be designed as a film and enclose the evacuated core materials. In this case, the insulating core can, for example, be made of flat boards that are assembled into a three-dimensional contour.

However, the heat insulation layer is preferably made as a one-piece three-dimensional (for example, bowl-shaped) contour and then enclosed with the barrier layer.

The walls of transport containers can advantageously have manufacturing process-integrated barrier layers which can be fabricated by means of multi-component injection molding or flooding of flat foil inserts, for example. Subsequent coating, for example, by means of sputtering or vaporizing or through deposition or affixing of the barrier layers is also possible. In this case, the preassembled heat insulation layer is placed between the transport container walls, the setup pumped down and then welded with gas-tight bonds.

An essential feature of the heat insulation layer is that it circumferentially surrounds the transport container. The abutting edges between lid and container wall have low thermal conductivity and thereby prevent heat loss at the contact points. Materials with high specific heat capacity and low thermal conductivity are preferably used here (for example, highly cross-linked and/or stretched polymers such as HP-PE). Furthermore, outer and inner wall advantageously exhibit high impact strength. The inner shell can advantageously be made of a material with high specific heat capacity.

Moreover, the heat insulation layer can have at least one, preferably two, openings for the injection of thermal mass.

The transport container also advantageously has a storage layer for the receiving of thermal mass. This storage layer can have one or more storage compartments for thermal mass, which, for example, can be designed as a cavity between two walls of a multi-wall tank, for example. The storage compartment or storage compartments can also have a canal-like structure for targeted distribution of the thermal mass. The storage compartment or storage compartments can, for example, have a meandering or labyrinthine design.

The storage layer, however, can also be designed as a separate component inside the transport container, detachably mountable and hence removable as needed. In this case, the storage layer is designed as a fillable bag. The storage layer preferably has a three-dimensional design so that it at least roughly replicates the inner surface of the bottom part of the transport container so that the exterior of the storage layer is resting at least partially on the inner wall of the bottom part of the transport container.

The storage layer can be designed as a disposable product for single use. The storage layer can, for example, be made of a plastic film of polyethylene or another suitable material. The storage layer can also, for example, be made of double-walled film, wherein one or more storage compartments for thermal mass are formed between two film layers. The external film (that is, the film facing the inner wall of the bottom part of the transport container) can, for example, have a reflective coating to produce good heat insulation. Moreover, the internal film (that is, the film facing the transported goods) can, for example, have a black coating to produce good heat transfer.

Furthermore, the bag can have a two-chamber system, wherein the second chamber, independently of the first, can be filled with a dampening material such as air or oil. Vibration-sensitive products such as clocks or suspensions can thus be transported safely on the bag.

A storage compartment can have a meandering or labyrinthine design. A storage compartment can be designed so that it can accept a defined quantity of thermal mass without the films experiencing elastic deformation. If more than the defined quantity of thermal mass is injected, then the films experience elastic deformation. The stress condition thus created in the film material can achieve optimal distribution of the thermal mass inside the respective storage compartment.

Preferably the heat insulation layer is facing the exterior of the transport container and the storage layer is facing the interior of the transport container and hence the product to be transported.

The transport container can also have, in a suitable place, means for adding and removing the thermal mass. This type of means, which can be disposed on a bottom part and/or on a transport container lid, can comprise one or more valves, for example, so-called double seat valves, lip valves or, in case of the bag, additional foil valves. These filling ports can be located on the transport container or on the bag. Double seat valves and lip valves have the advantage of simultaneously allowing the supply or removal of thermal mass and the venting or aerating of the storage compartment. The filling takes place through openings on the insulation, enabling filling in the closed position of the transport container.

In embodiments where the storage layer is designed as a separate mountable component inside the transport container, the means for adding and removing thermal mass can be a component of the storage layer and can be removed with the latter from the transport container. For this purpose, the bag can, for example, be equipped with carrying handles so that inside products can be removed all at one.

The means for adding and removing thermal mass are advantageously positioned so that the thermal mass can be supplied even when the transport container is closed and without opening it, thus providing additional security.

A means for adding and removing thermal mass is preferably disposed on the upper side of the lid. Furthermore, another means for adding and removing thermal mass is preferably disposed on the underside of the lid.

A storage layer made of double-walled plastic film can, for example, comprise one or two valves (for example, double seat valves or lip valves) which are detachably insertable into corresponding recesses of the bottom part of a transport container so that their positions are defined and specified relative to the bottom part. Furthermore, the transport container lid in the area of the valve or valves, for example, can have holes or gaps that ensure access to the valve or valves from the outside even when the lid is closed.

The transport container can also have, in a suitable place, one or more sensors (for example, temperature sensors or humidity sensors) to determine the temperature profile of the transported goods during transport as well as record it as needed.

This type of sensors can, for example, be mounted on an inner wall of the bottom part and/or of the transport container lid and be injected in a plastic material or be glued, for example. In the same manner, strip conductors connected to the sensor or sensors can be mounted on or in the container to transmit measured values. Alternatively, sensors can be disposed on or in the storage layer.

If the storage layer is a separate component inside the transport container, detachably mountable and hence removable as needed, as described above, then the sensor and the associated strip conductors can, for example, be mounted directly on the storage layer. Strip conductors made of conductive grease can, for example, be imprinted onto a film of the storage layer and a sensor can be glued onto connecting terminals of the strip conductors using conductive adhesive.

The sensors can likewise be components of the aforementioned electronic circuit. A sensor disposed inside the transport container can, for example, be connected to a control unit through electrical cables (for example, strip conductors that can also be mounted on a separate carrier substrate) so that signals can be transferred.

In this case, for example, the other ends of strip conductors disposed on the storage layer can be disposed near the means for adding and removing thermal mass so that when the transport container is closed a signal-transferring connection is established between the sensor and a control unit disposed, for example, in the transport container lid. To this end, the lid preferably has relevant points of contact near the means for adding and removing thermal mass, which belong to strip conductors leading to the control unit.

The electronic circuit can, for example, comprise a nonvolatile storage component that is describable by the control unit using measured values of the sensor.

The control unit can also contain a clock (RTC) that allows clocked recording of measured values through querying of the sensor in definable intervals. The measured values, in this case, can also be written in the storage component as a pair of values of temperature or humidity and time stamp, for example. The measured values can be read out and forwarded by the control unit from the storage component, which can also be integrated in the ASIC or MCU, for example, to a display for optical output in numerical form or as a barcode, QR code or the like, and/or to an RFID, which can likewise be a component of the ASIC, contactless to a specifically equipped reader device such as a smartphone, for example.

The proposed methods and devices are explained in more detail below using embodiments and associated drawings. The drawings,

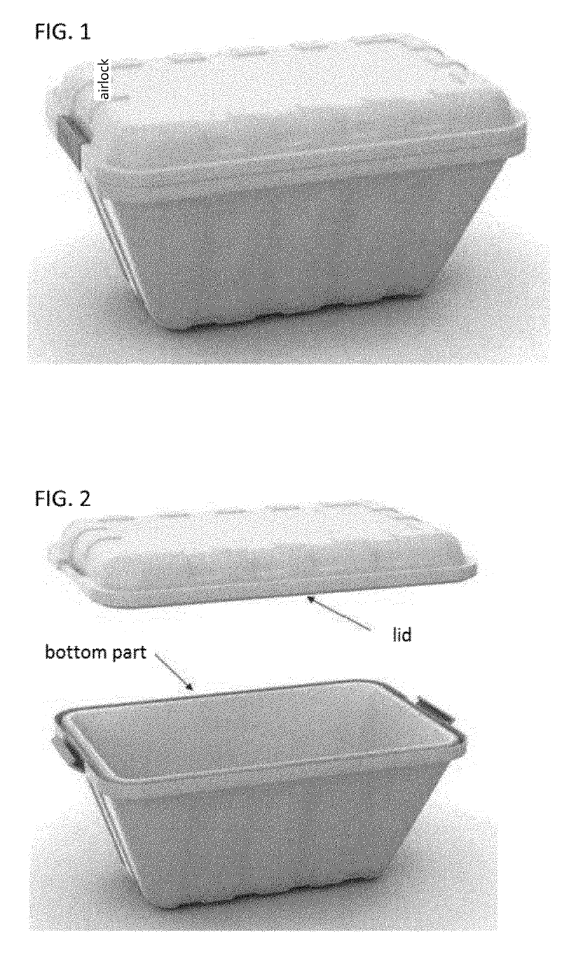

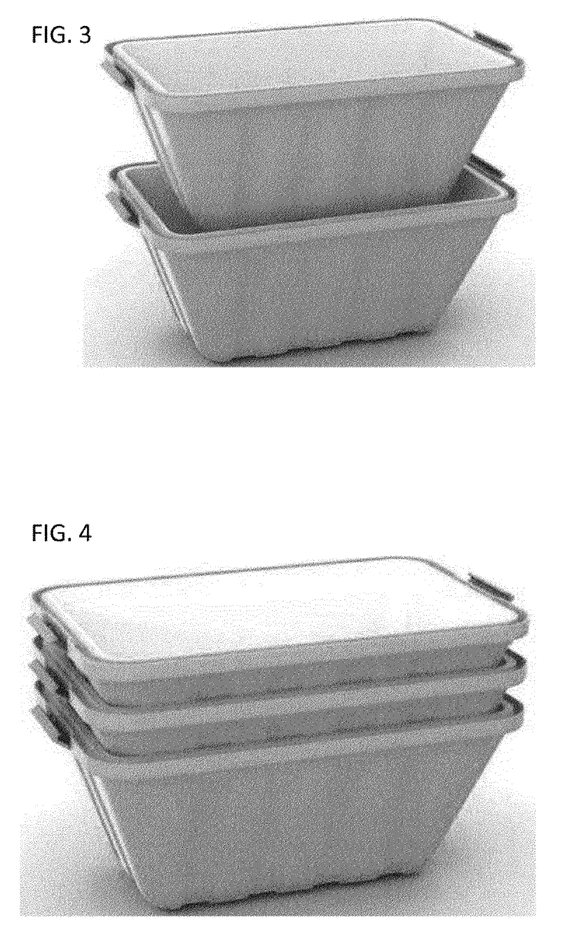

FIGS. 1 to 4 show a transport container according to a first embodiment,

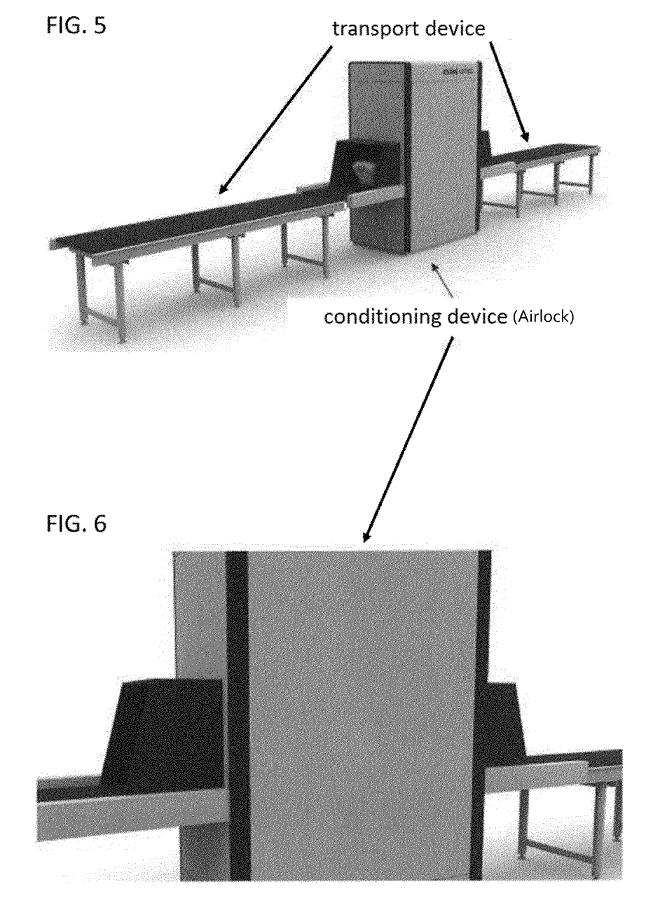

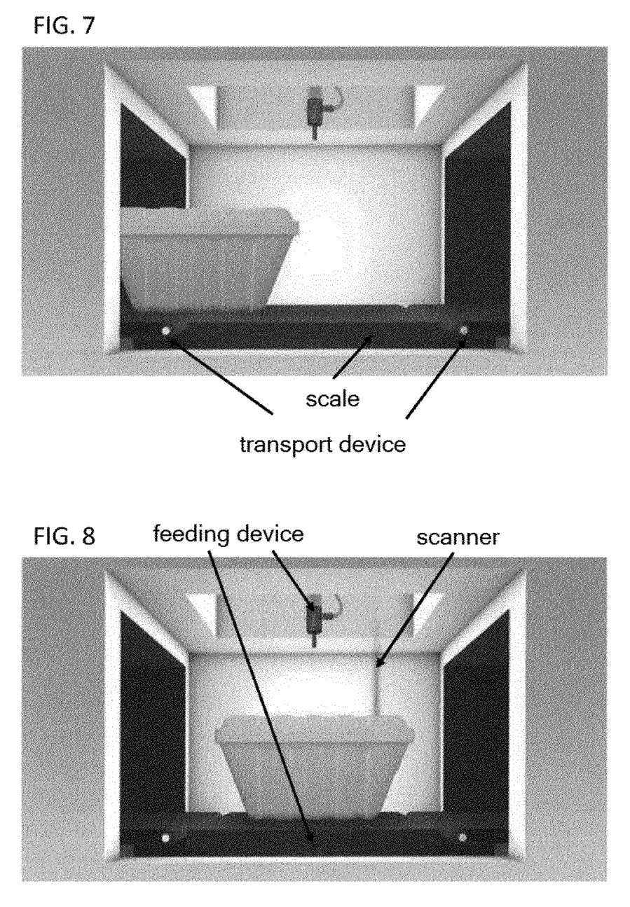

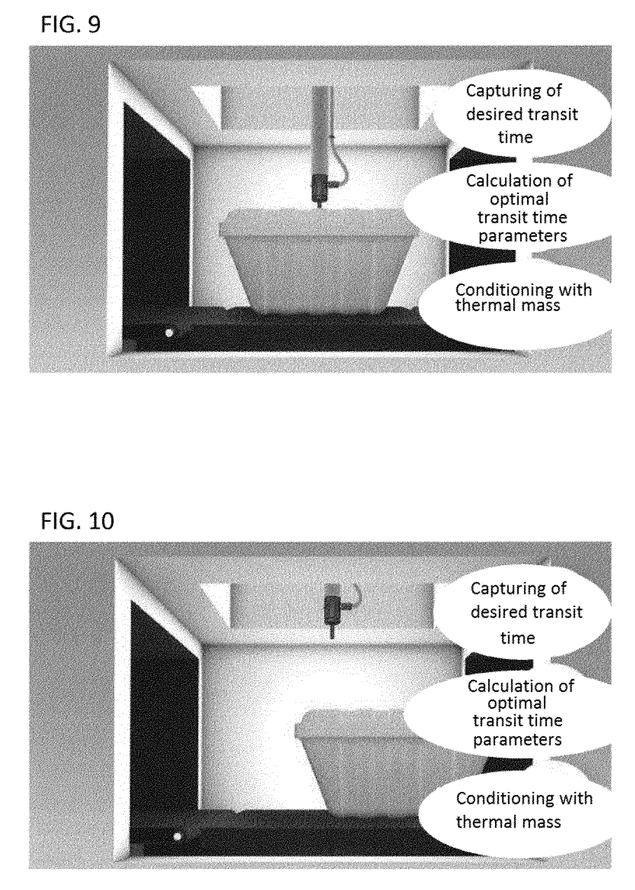

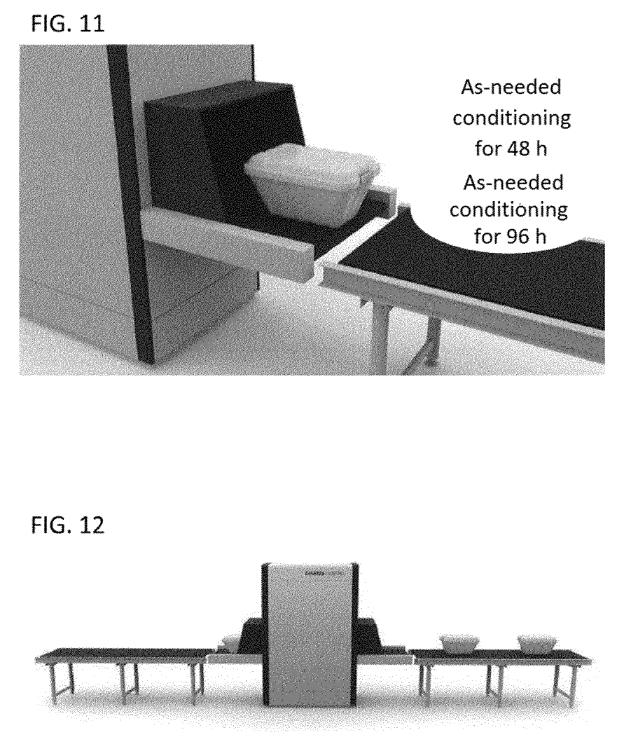

FIGS. 5 to 12 show a conditioning device according to a first embodiment,

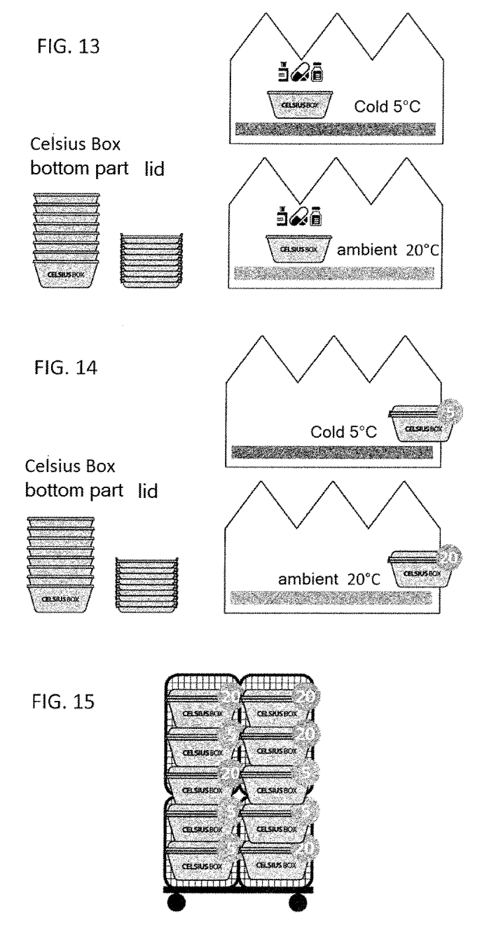

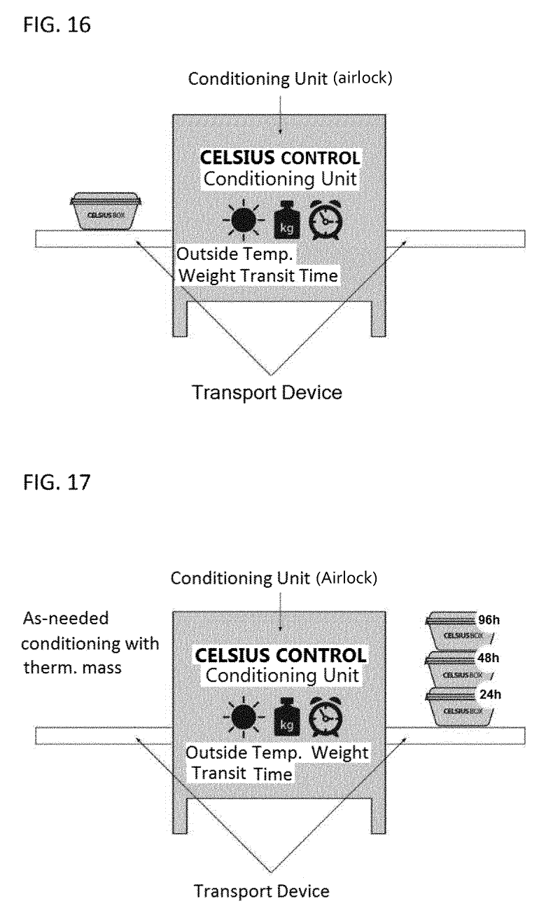

FIGS. 13 to 17 show aspects of a transport method according to a first embodiment,

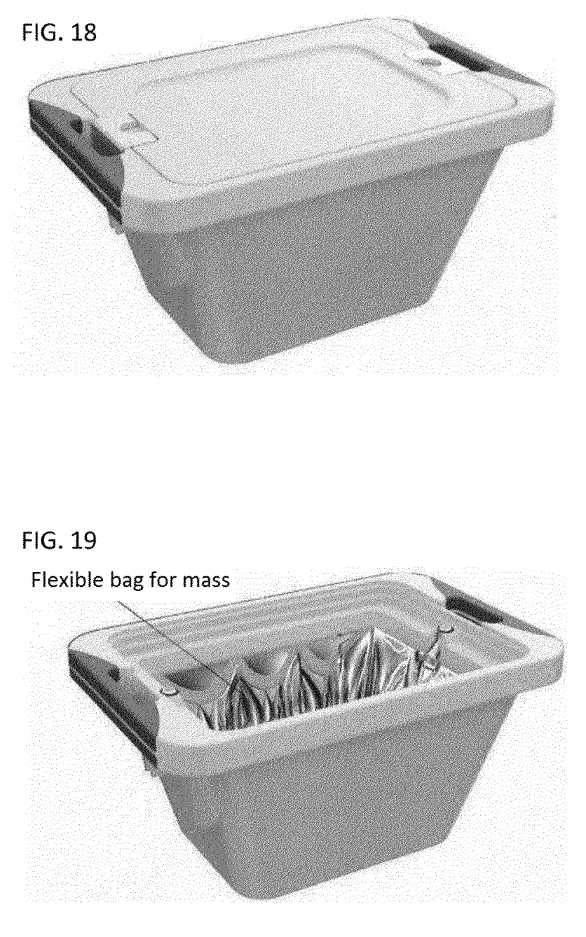

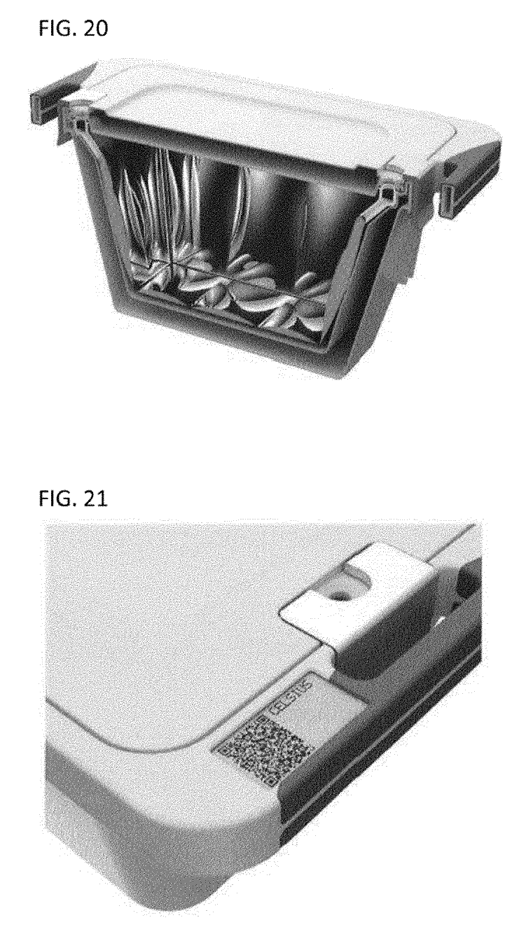

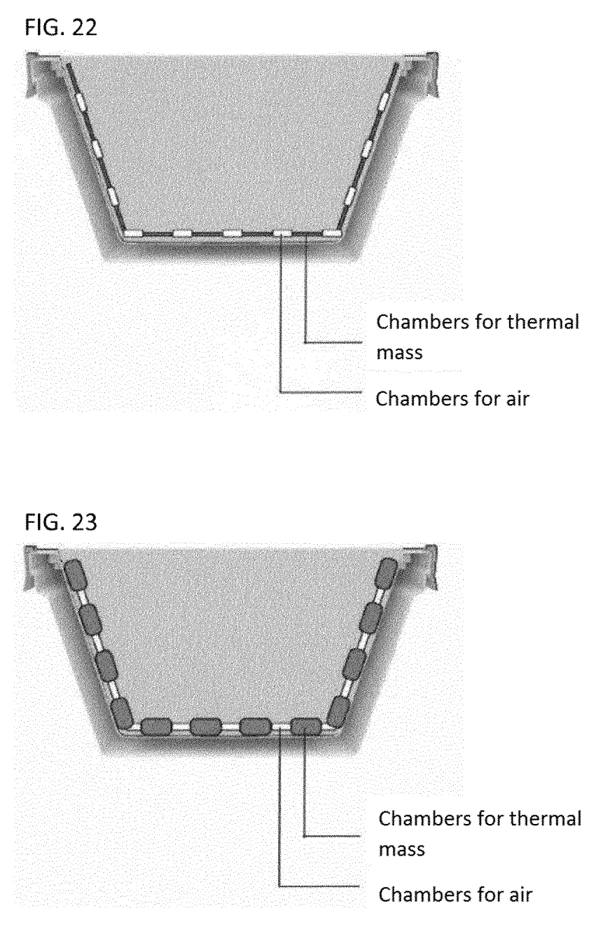

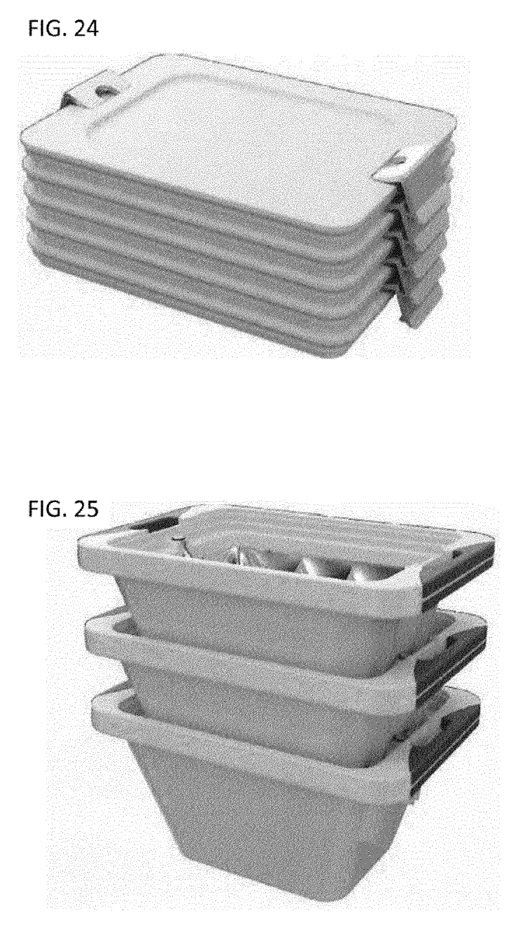

FIGS. 18 to 25 show a transport container according to a first embodiment,

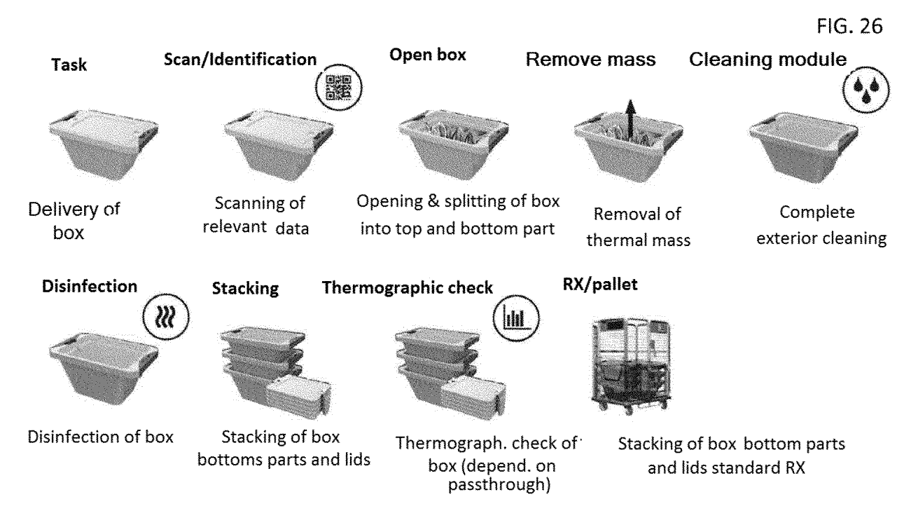

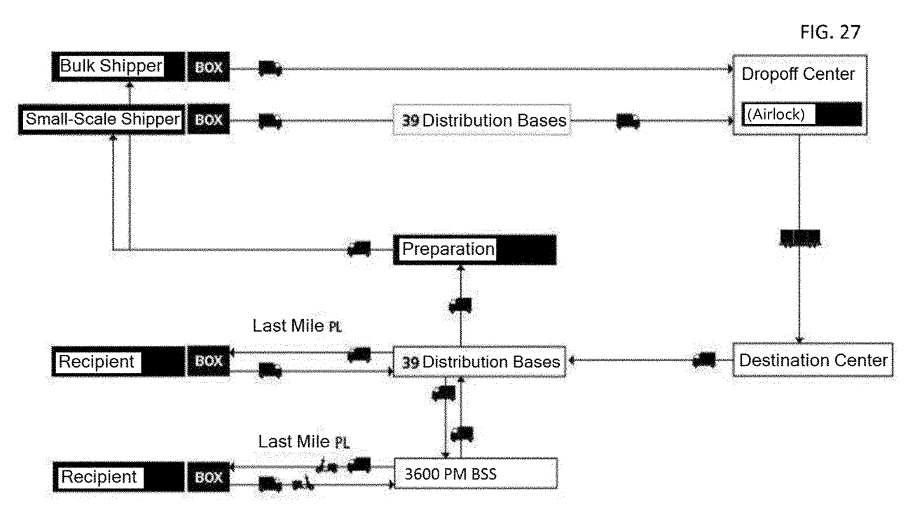

FIGS. 26 and 27 show aspects of transport methods according to further embodiments,

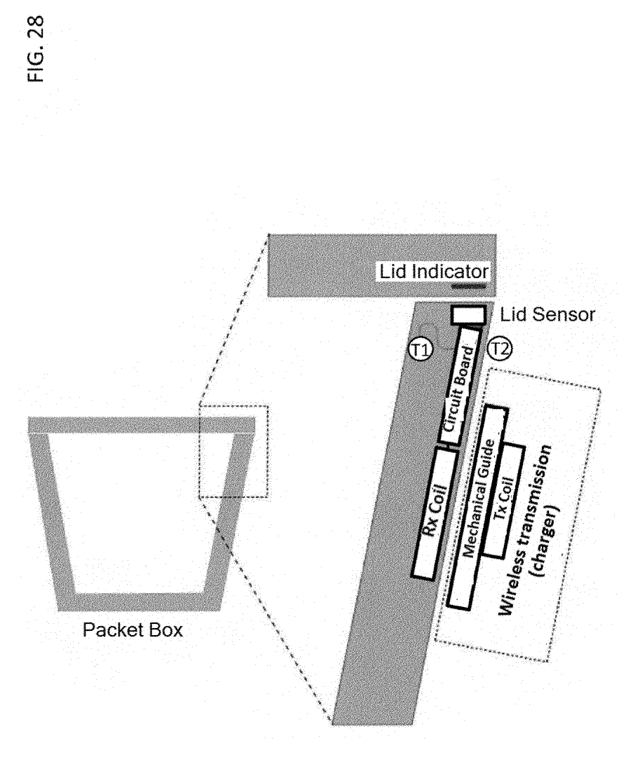

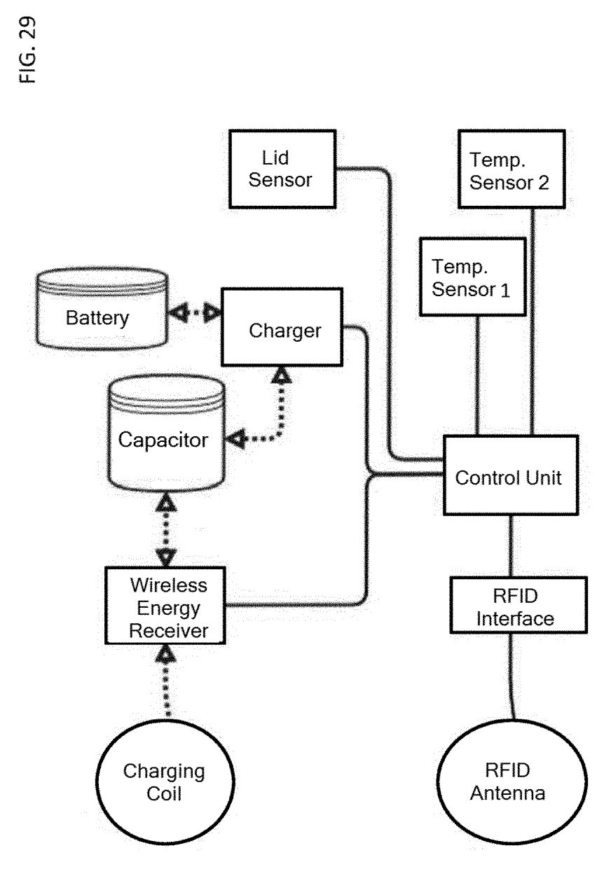

FIGS. 28 and 29 show aspects of transport containers according to further embodiments,

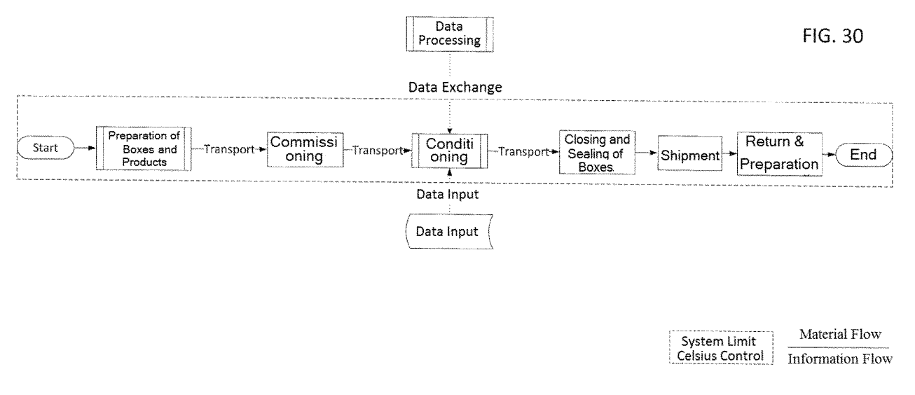

FIGS. 30 to 32 show aspects of transport methods according to further embodiments, and

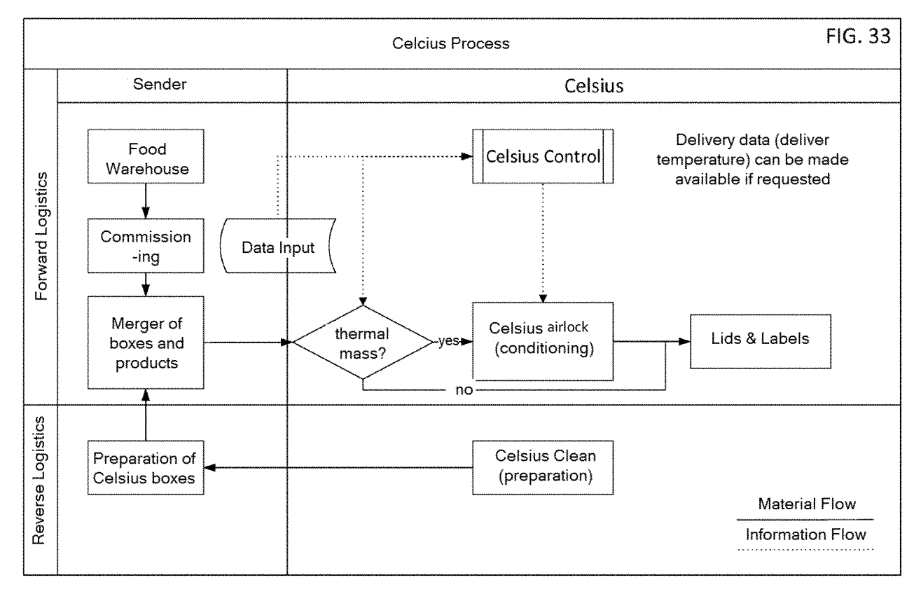

FIGS. 33 to 37 show aspects of transport methods according to further embodiments.

Sample embodiments of the proposed transport container are shown in FIGS. 1 to 4, with the diagram not showing the means for adding and removing thermal mass.

The transport container shown in FIGS. 1 to 4 according to a first embodiment allows the reliable and GDP-compliant transport of temperature-sensitive products in any temperature range and in any type of weather.

The multi-layer wall system of the transport container also has fillable cavities apart from vacuum interstices. The upper and lower part can be conditioned separately with thermal mass as required.

The interior of the transport container meets all common hygiene requirements. A soft coating inside and outside ensures slip resistance even during processing in the parcel center.

Due to its small wall thickness up to 13 transport containers can be stacked per meter with an effective volume of around 30 liters each.

The thermal mass can, for example, be water or brine, wherein the thermal mass can also be designed as a gel.

To determine the performance of the insulation, a thermodynamic measurement and/or calculation can, for example, be made with the following parameters:

### Example: Assumed Product Transit Time 24 Hours

Assumed outside temperature over 24 hours: −6° C.

Assumed product temperature at start 20° C. (ambient).

Desired final temperature at recipient 15° C. to 25° C.)

The measurement produces a performance diagram which is used as a basis for the implementation of the method.

A measuring tool can be provided advantageously to calculate parameters of individual transport containers and a data processing device can be provided advantageously to calculate the thermal mass to be added. The measuring tool and the data processing device can be interconnected advantageously through a means for data transmission.

A measuring tool can, for example, have the following features:

A device to identify the size and/or weight of the transport container and/or of the product to be transported, for example, a scanner for contactless data acquisition.

A measuring tool to determine weight (total weight of transport container and product), for example, a scale.

An apparatus to incorporate any required thermal mass into the closed packaging.

A data processing device can, for example, comprise a data processing device such as a computer unit with the following basic configuration, for example:

Data from a performance diagram for the thermal output of a transport container, for example, data about parameters characterizing the heat insulation properties of the transport container.

Data about the outside temperature at the starting location, wherein the data processing device can be connected to an outside temperature sensor through a means for data transmission.

Stored temperature profiles (e.g. characteristic diagrams) for various desired temperature ranges and/or outside temperatures relative to the desired transit time.

Permissible final temperature of the transport container and/or of the product to be transported at the destination, factoring in the desired transit time (ambient or cold or frozen).

Data about the percentage share of various thermal masses on the product to be transported, for example, based on a database containing such data for various products.

### Example: Every Product has a Specific Proportion of Thermal Mass that is of Great Importance to Temperature-Controlled Transport

When calculating the required thermal mass to carry out the transport, the specific mass of the product, for example, is determined under the assumption that the product to be shipped consists of 30% plastic, 30% cardboard and 40% liquid.

This results in the energy rating of the thermal mass. The actually required quantity of thermal mass is calculated from the characteristics: Actual initial temperature, product weight, transit time as well as performance diagram of the packaging and desired delivery temperature.

Based on the above parameters, it can be determined how high the proportion of thermal mass of the transport container must be in order to reach the desired transit time within the desired temperature range. The thermal mass present in the product is taken into consideration here, accordingly.

Based on the aforementioned calculation, the missing thermal mass is supplied to the transport container.

Sample sequence of the method:
Calculation of the necessary data (parcel dimensions, place of consignment, destination, temperature on the route to the destination, temperature range to be maintained),
Calculation of the probable maximum transit time from the starting location to the destination, taking account of Sundays and holidays,
Decision as to whether the package must be filled with thermal mass and if yes, how much mass has to be injected,
Definition of the maximum possible transit time until delivery,
Transport of the transport container to the recipient and delivery.

Optionally it can be provided that the recipient is only sent a code needed to open the transport container if the package was delivered on time and/or if the temperature inside the transport container during the entire transport was within the defined temperature range.

An advantage of the proposed method is that based on known outside temperatures it can be assumed that no thermal mass is needed to carry out safe transport on at least 100 transport days per year.

Moreover, need-based over-conditioning of the thermal mass can significantly improve the insulation capacity of transport containers and reduce the weight.

The method can, for example, be designed as follows, as shown schematically, first of all, in FIGS. 5 to 12 and then in FIGS. 13 to 17:

The empty transport containers are loaded by the shipper, closed and if, needed, transported in sealed condition to the parcel center. There is no need for additional activities.

In the parcel center, the closed transport containers go through the conditioning device or filling device. This includes, as shown in FIGS. 5 and 6, an upstream and downstream conveyor belt each and an airlock. The thermodynamic prerequisites to satisfy the transport order are calculated automatically here and the transport containers are conditioned according to their transit time.

A transport container prepared by the shipper is moved to the airlock via a first conveyor belt and placed on a scale.

Disposed in the autonomous airlock is a scanner that records data about the size and weight of the transport container and/or the product contained therein or/and the desired transit time. The acquired data is forwarded to a data processing device. Moreover, disposed in the airlock is a scale on which the transport container is first placed. The scale weighs the transport container. The acquired data is forwarded to a data processing device. The data thus acquired is supplemented in the data processing device (which can be a component of the airlock, but can also be in the form of a separate computer) with additional data on outside temperature and/or transport time and/or desired temperature range, etc. and the optimal parameters for the transport are calculated from this.

Every transport container can be conditioned on this basis according to need and requirement. In the embodiment, two feeding devices are disposed in the airlock for this purpose. A first feeding device is connectable to a valve at the upper side of the lid by means of lowering. A second feeding device protrudes through a corresponding opening in the scale and is connectable to a valve at the underside of the lid by means of raising. The feeding devices, controlled by the data processing device, add the necessary quantity of thermal mass to the lid or the bottom part of the transport container by admitting this quantity into the storage layers of lid and bottom part through the respective valves.

The fed thermal mass can, for example, be held already conditioned as desired (for example, in a storage tank). However, alternatively, the thermal mass can also be brought to the needed temperature only immediately before filling of the transport container, for example, by having the feeding device have a flow-through cooler.

The feeding devices can be optionally and additionally designed so that they first remove still existing thermal mass from the respective storage layer and then fill the storage layers of the transport containers with fresh, conditioned thermal mass.

Otherwise it goes without saying that the proposed method also delivers the desired result if only the lid or only the bottom part of the transport container is conditioned.

While prior methods only work with static conditioned thermal mass such as cold packs or the like, for example, the compact airlock automatically fills the closed transport container with variable thermal mass in a few seconds and thus ensures the transport in the required temperature range.

The as-needed conditioning of transport containers can be carried out for transit times of over 96 hours. Parameters are automatically adjusted depending on the day of shipment and the prevailing climatic conditions to also ensure the reverse logistics. If, for example, a transport container is prepared for shipping on Friday, this can then ensure that no departure from the given temperature range itself takes place, even if the transport container with the product to be transported only arrives in the parcel center on the following Monday.

The proposed method offers your customers, for example, a future-proof GDP-compliant logistical solution for all types of temperature-controlled transport.

The transport container shown in FIGS. 18 to 25 according to a second exemplary embodiment allows the reliable and GDP-compliant transport of temperature-sensitive products in any temperature range and in any type of weather.

It comprises a bottom part and a waterproof lid, hermetically lockable with the bottom part. The bottom part has a double-wall design so that a cavity is formed that is pumped down, thereby serving as a heat insulation layer.

Disposed inside the bottom part is a storage layer that is designed as a separate component inside the transport container, detachably mountable and hence removable as needed. The storage layer has a three-dimensional design by means of which the exterior of the storage layer is at least partially resting on the inner wall of the bottom part of the transport container.

The storage layer is double-walled and is made of polyethylene film, wherein several storage compartments for thermal mass as well as several storage compartments for air are formed between two film layers.

Furthermore, the storage layer comprises two valves for adding and removing the thermal mass which is detachably inserted in corresponding recesses of the bottom part of the transport container so that its positions are defined and specified relative to the bottom part. The transport container lid has one hole each in the area of both valves, ensuring access to the valves from outside even when the lid is closed.

The lid has two closure elements that are designed as claws that are hinged to the transport container lid and overlap with arranged sections on the bottom part in the closed position. In the area of both valves they have a cavity that ensures access to the valves from outside even when the lid is closed.

Disposed in the lid or in the bottom part is an electronic circuit that activates a display to show specific data in plain text or in encrypted form, for example, a unique ID number of the transport container and/or data about the transported goods (for example, the mass), and/or the sender and/or the recipient and/or a temperature range to be maintained for the transported goods and/or temperature data of the transported goods (for example, exceeding or falling short of a temperature threshold), and/or an authorization code or data needed to generate an authorization code or the like. The electronic circuit has an interface for contactless data exchange, for example, a read-write device.

FIG. 26 shows a partial method for preparing the transport containers after their use. In this method, after the delivery of the transport container, the data stored in the electronic circuit is first read out by means of contactless data connection and/or in the form of a QR code. The transport container is then opened and the storage layer with the thermal mass removed. Since the storage layer is designed as a disposable product, this is disposed of. The container is then cleaned, disinfected and subjected to a thermographic check. Finally, the bottom parts and the lid of the transport containers are stacked and supplied to refilling.

FIG. 27 shows the transport of transport containers during the shipment of transported goods by a sender (bulk mailer, small-scale shipper) to a recipient. The sender fills the transport container with the transported goods and furnishes the transport container with relevant data such as recipient address, weight of transported material, for example, wherein this data can be distributed, for example, in liquid and/or solid weight fractions of the actual transported goods and paper/cardboard and/or plastic, and the temperature range tolerated during transport.

The transport containers are then transported to the drop-off center either directly or through a distribution base where the shipments are collected and then forwarded to the drop-off center.

There, the data created by the sender is read out, the expected transport time determined, the thermal mass requirement calculated and the storage layer filled accordingly with conditioned thermal mass.

The transport containers are then transported from the drop-off center to the destination center. From there, the transport containers are brought to the recipients either directly or through distribution bases and business support systems.

After the recipient has received the transported goods, the empty transport containers are taken for processing and then made available again to senders to render their goods ready for dispatch.

FIGS. 28 and 29 show an exemplary embodiment of a transport container with an electronic circuit. The electronic circuit can, for example, be mounted on a container wall of the transport container. To supply power to the electronic circuit, it can have an energy storage system, for example, a capacitor (super capacitor) and/or a galvanic cell (here: secondary cell, chargeable battery).

Energy can be fed inductively through a receiving coil (RX coil, charge coil) to this energy storage system which is sufficient for the uninterrupted operation of the electronic circuit during transport of the transport container from the starting location to the destination. For this it is sufficient to maintain a charging device (wireless power transfer (charger)), which has a transmitting coil (TX coil), outside on the container wall in the area of the electronic circuit.

The electronic circuit itself has a printed circuit board (PCB) which carries and interconnects the electronic components. Apart from a microcontroller (MCU), the exemplary embodiment has two temperature sensors and a lid sensor that captures whether the transport container is open. The microcontroller has memory capacity for data and is connected to an antenna (RFID antenna) through an interface (RFID interface), thus ensuring wireless data exchange.

FIGS. 30 to 32 show an exemplary process sequence.

FIG. 30 shows an overview of the conditioning process: In the beginning of the process, the transport containers (boxes) and the products to be transported (transported goods) are made available. The transport containers are picked, that is, the products are packed in the transport containers.

Next, conditioning takes place, that is, the need-based filling of the transport containers with thermal mass. Here, relevant data for the concrete shipment is first determined, that is, inputted (data input). The required thermal mass for this shipment is determined based on this data (data processing). After conditioning, the transport container is closed and provided with a tamperproof seal.

The transport container with the transported goods is transported and delivered to the customer. The customer takes the product and hands over the transport container to the carrier. The latter brings the transport container back to the shipper, where the transport container is cleaned and prepared for the next shipment.

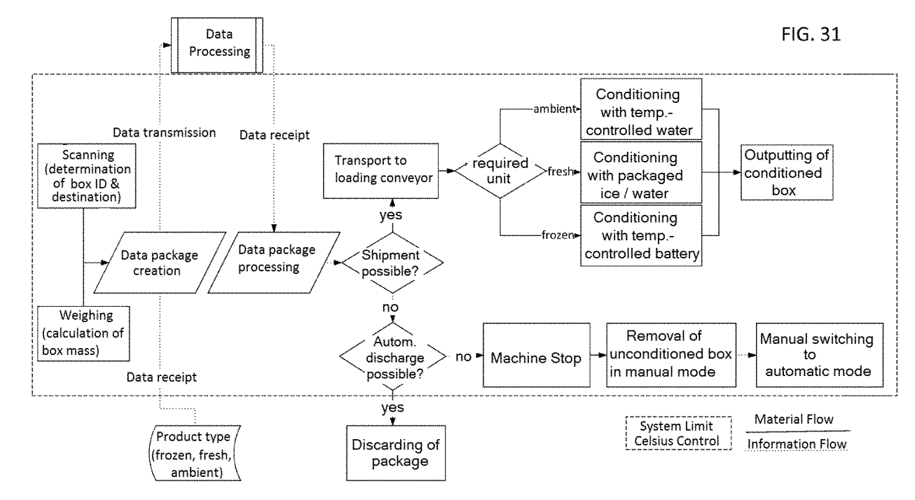

FIG. 31 shows the processes in the apparatus (Celsius airlock) used for the conditioning:

For data processing immediately prior to the conditioning, for example, the transport container is identified using its identification number, the transported goods or the transport container with the transported goods is weighed and the temperature range to be maintained is defined using the product type or read out from a database. This data is combined in a data package that is used to calculate the required thermal mass.

If transport in the desired temperature range within the required transport time is possible, then the transport container is conditioned with the required type and quantity of thermal mass. However, if transport in the desired temperature range within the required transport time is impossible, then the transport container is automatically or manually discarded.

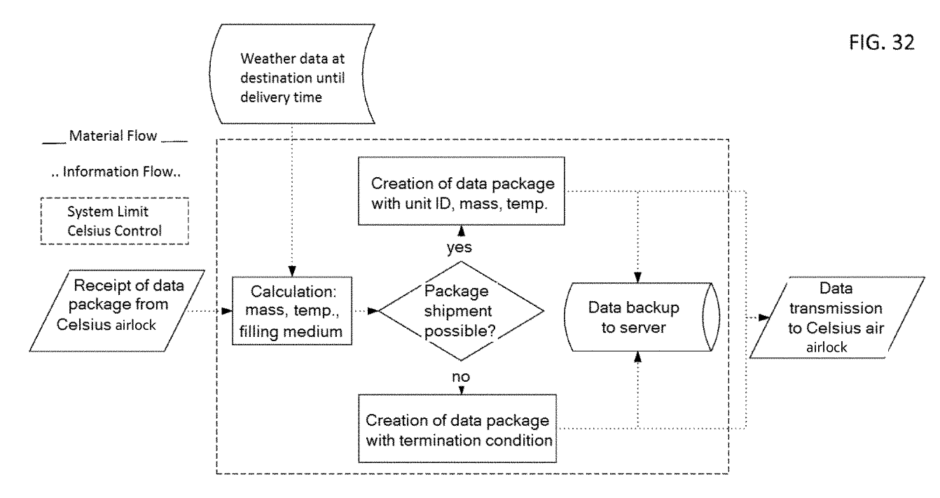

FIG. 32 shows the processes in the software (Celsius Control) executed on a data processing device of the apparatus (Celsius airlock):

The inputted data package is merged with geographic and meteorological data (distance from delivery location and/or expected transit time, temperatures at the starting location and/or destination and/or between starting location and destination) and the quantity and temperature of the required thermal mass calculated.

If transport in the desired temperature range within the required transport time is possible, then a new data package is created with the identification number of the transport container and the required type and quantity of thermal mass, and this is used in the apparatus for conditioning control, on the one hand, and is stored in a database, on the other hand. However, if transport in the desired temperature range within the required transport time is impossible, then the new data package contains this information. It is then transmitted to the apparatus for the outfeed of the transport container, on the bone hand, and likewise stored in the database, on the other hand. The database in the exemplary embodiment is located on a server to which the data processing device of the apparatus can be connected through a data network.

FIGS. 33 to 37 show another exemplary process sequence.

FIG. 33 shows the basic overall process which is very similar to that in the previous exemplary embodiment. The shipper of transported goods (for example, foodstuff) receives transport containers (Celsius boxes) from the logistics provider (Celsius) and processes these into orders with the foodstuffs. Together with the required data such as recipient, type and quantity of transported goods, the transport containers are transported to the logistics provider, where a computer software (Celsius Control) determines whether and, if necessary, which thermal mass in what quantity must be supplied to the transport container. If transport in the desired temperature range within the required transport time is possible, then the transport container is conditioned with the required type and quantity of thermal mass and then closed and, if necessary, furnished with data for the shipment. However, if transport in the desired temperature range within the required transport time is impossible, then the transport container is discarded.

After delivery of the shipment at recipient, the transport container is sent back to the logistics provider, cleaned and prepared, and the cycle begins all over again.

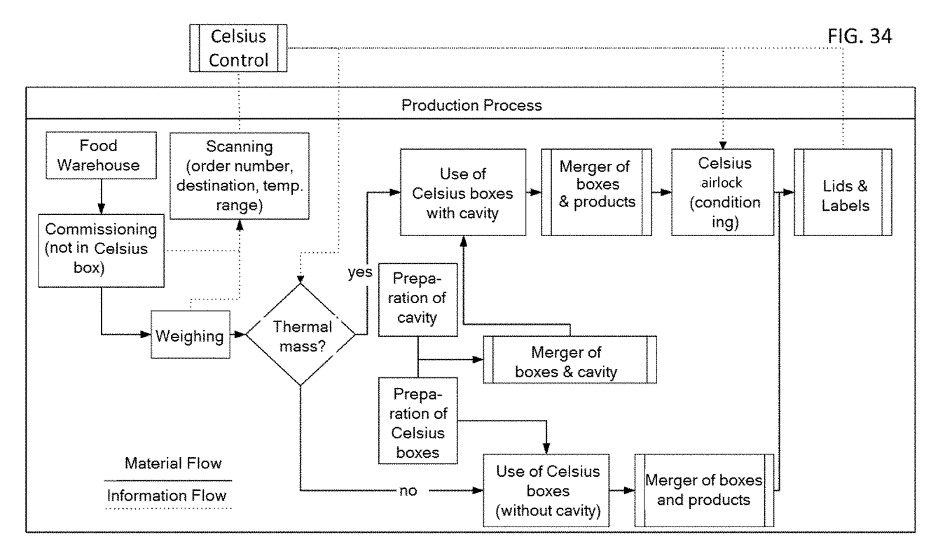

FIG. 34 shows a variation of conditioning in detail in which the logistics provider packs the transported goods in the transport container. The shipper hands over the goods with the data needed for the shipment (e.g. order number, destination, desired temperature range) to the logistics provider who reads this data and determines through data processing (Celsius Control) whether and, if necessary, which quantity of which thermal mass is needed for the transport. If the calculation determines that no thermal mass is needed, then a transport container having no thermal mass cavity is selected, the transported goods are packed therein and the transport container is closed and furnished with a label indicating the recipient. Otherwise, a container is furnished with a thermal mass cavity or a transport container having such a cavity is selected, the transported goods packed therein, the cavity filled with the required thermal mass and then the transport container is closed and furnished with a label indicating the recipient.

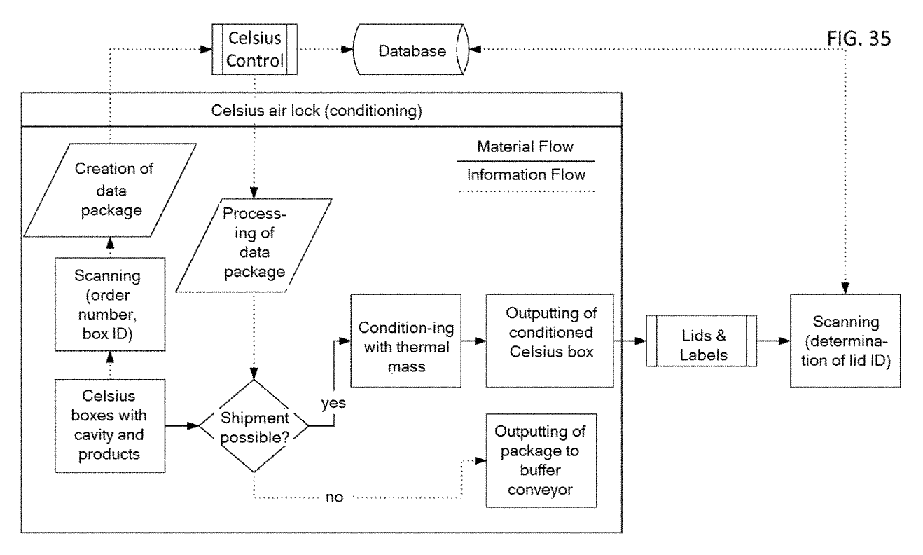

FIG. 35 once again shows in detail the processes in the apparatus (Celsius airlock). Transport-relevant data such as order number, identification number of the transport container, etc. is read out from the electronic circuit of the transport container (Celsius box) in the software (Celsius Control), which is executed on a data processing device of the apparatus, a data package is created and it is calculated whether transport within the required time in the desired temperature range is possible and, if yes, which thermal mass in which quantity is needed for this purpose.

If transport in the desired temperature range within the required transport time is possible, then the transport container is conditioned with the required type and quantity of thermal mass and then closed and, if necessary, furnished with data for the shipment. However, if transport in the desired temperature range within the required transport time is impossible, then the transport container is discarded.

All read out, calculated and written data is stored in a database.

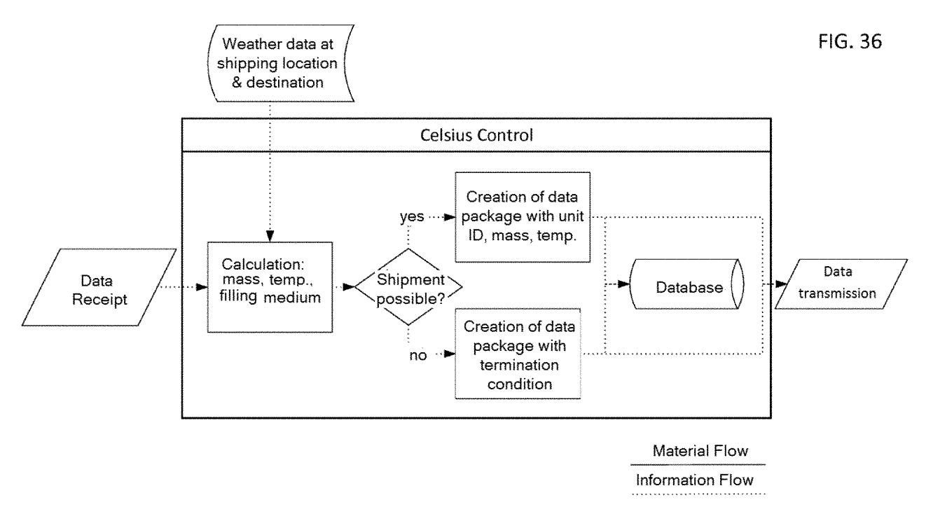

As evident from FIG. 36, the software (Celsius Control) does not only receive the data read out from the transport container and/or otherwise supplied by the shipper, but also accesses meteorological data (that is, weather data at the starting location and destination, for example) through a data network. This data is also used in the calculation because it has a decisive effect on the thermal mass requirement. The data thus determined with regard to the decision as to whether transport in the desired temperature range within the required transport time is possible, and which quantity of which thermal mass for this purpose is to be filled, if necessary, into the transport container is stored in a database together with the identification number of the transport container and returned to the apparatus (data transmission) for conditioning control as well as the storage of transport-relevant data in the transport container.

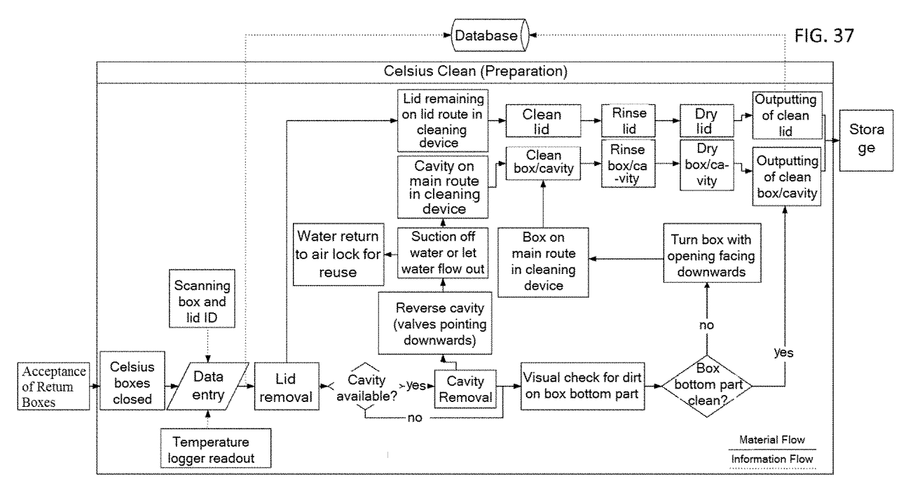

FIG. 37 shows the further process sequence after the transport container is returned by the recipient (Celsius Clean (Preparation)) as an example for this exemplary embodiment.

After the transport containers are returned to the logistics provider, the data stored therein (for example, the identification number, measured temperature data of the interior, etc.) is read out. The lid is removed from the bottom part and washed in a cleaning device, rinsed, dried and, after completion of cleaning, stored for the next application.

If the transport container has a thermal mass cavity, this is removed from the bottom part, the thermal mass emptied and the cavity washed in a cleaning device, rinsed, dried and, after completion of cleaning, stored for the next application.

The bottom part is inspected visually for contamination. If the bottom part has no problems, it can be stored immediately. Otherwise, it is washed in a cleaning device, rinsed, dried and, after completion of cleaning, stored for the next application.

1. A method for implementing of transports of temperature-controlled products, wherein a transport container containing a product having a product weight is supplied with a preconditioned thermal mass before a start of transport, quantity of the thermal mass supplied being computationally calculated in advance on the basis of thermodynamically and/or logistically relevant data including product weight and/or a starting location and destination and/or estimated transport time and/or weather data at the starting location and/or at the destination and/or between the starting location and destination and/or a temperature range to be maintained.

2. The method according to claim 1, wherein information that is saved or displayed on, to or in the transport container or a label, an electronic circuit, or a display of the transport container is read out and processed.

3. The method according to claim 1, wherein, after the transport container is filled with thermal mass, information is affixed on, to or in the transport container or a label or other component of the transport container or stored in an electronic circuit.

4. The method according to claim 1, wherein a temperature inside the transport container during transport is continuously recorded and saved.

5. The method according to claim 1, wherein data needed to open a transport container is transmitted to a recipient of the transport container.

6. The method according to claim 5, wherein the data is only transmitted if the transport time has not exceeded a pre-selectable time period.

7. The method according to claim 5, wherein the data is only transmitted if the temperature inside the transport container during transport has not departed from a pre-selectable temperature range.

8. A transport container, comprising a bottom part and a connectable lid hermetically sealed with the bottom part, wherein the bottom part and the lid have interacting closure elements that can be closed and/or sealed without any possibility of tampering.

9. The transport container according to claim 8, wherein at least one container wall of the top part and/or of the bottom part of the transport container includes a heat-insulating layer.

10. The transport container according to claim 9, wherein the heat-insulating layer contains amorphous silicon dioxide as an insulating material.

11. The transport container according to claim 9, wherein the heat-insulating layer has an impermeable shell enveloping the insulating material and is pumped down.

12. The transport container according to claim 9, wherein the heat-insulating layer is a one-piece three-dimensional structure following a contour of the bottom part or the top part.

13. The transport container according to claim 9, wherein the heat-insulating layer is embedded in a container wall.

14. The transport container according to claim 8, which has at least one cavity fillable with thermal mass.

15. The transport container according to claim 14, wherein the at least one cavity is disposed in one container wall.

16. The transport container according to claim 14, wherein the at least one cavity is disposed in a flexible bag insertable into the transport container and removable from the transport container.

17. The transport container according to claim 8, wherein the at least one cavity has a filling port that is accessible when the transport container is closed.

18. The transport container according to claim 8, wherein the bottom part and the lid have interacting closure elements.

19. The transport container according to claim 18, wherein a closure element includes a lock that can be activated by electrical, magnetic or electromagnetic means.

20. The transport container according to claim 8, which has an electronic circuit for the recording and/or storage and/or provision of thermodynamically and/or logistically relevant data such as temperature and/or humidity and/or destination of the transport container.

21. The transport container according to claim 20, wherein the electronic circuit is operatively connected to a lock.

22. The transport container according to claim 20, wherein the electronic circuit is designed for wireless data transmission.

23. An apparatus for the preparation of transport of temperature-controlled products, comprising an apparatus for identification of a transport container and/or the size of the transport container or/and for capturing the product weight, and/or a measuring tool to calculate total weight of the transport container and product, a data processing device set up to calculate the required thermal mass and an apparatus to introduce any thermal mass that might be needed into the closed transport container.

24. The apparatus according to claim 23, wherein the data processing device is adapted for wireless data transmission.

25. The apparatus according to claim 23, wherein the data processing device is adapted for the reading of data from an electronic circuit of a transport container and/or for the writing of data into an electronic circuit of the transport container.

26. The apparatus according to claim 23, wherein the data processing device is connected to a database or a data network and receives data from the database or the data network and/or transmits data to the database and/or sends data to the data network.

27. The apparatus according to claim 26, wherein data about destinations and/or outside temperatures and/or delivery times is received.

28. The apparatus according to claim 26, wherein data needed to open a transport container or/and to calculate transport costs is transmitted or sent.

29. A computer program product which is executed in a data processing device of an apparatus according to claim 23.
